(19) United States
(12) Patent Application Publication
(10) Pub. No.: US 2016/0379207 A1
(43) Pub. Date: Dec. 29, 2016

(54) SECURED CREDENTIAL AGGREGATOR

(71) Applicant: INTEL CORPORATION, Santa Clara, CA (US)

(72) Inventors: Patrick Koeberl, Alsbach-Haenlein (DE); Nikhil M. Deshpande, Beaverton, OR (US); Anand Rajan, Beaverton, OR (US)

(73) Assignee: INTEL CORPORATION, Santa Clara, CA (US)

(21) Appl. No.: 14/750,992

(22) Filed: Jun. 25, 2015

(51) Int. Cl. G06Q 20/34; G06Q 20/22; G06Q 20/40

(52) U.S. Cl. CPC G06Q 20/3572; G06Q 20/341; G06Q 20/40145; G06Q 20/409; G06Q 20/227

(57) ABSTRACT

An apparatus for aggregating secured credentials is described herein. The apparatus includes a processor and a memory. The memory includes code causing the processor to provision a plurality of secured credentials on the apparatus. The code causes the processor to isolate the secured credentials from each other in the memory. The code also causes the processor to emulate a selected secured credential from the secured credentials for a transaction.

### TECHNICAL FIELD

This disclosure relates generally to secured credentials. Specifically, this disclosure relates to aggregating secured credentials onto a single device.

### BACKGROUND

Consumers today typically possess a number of credit, debit, gift, loyalty, and membership cards. This is inconvenient, and results in bulky wallets and purses. The majority of credit cards in the U.S. today are based on magnetic stripe technology, which is vulnerable to card cloning, or skimming. Skimming involves reading a card's stored data, and writing this data to another card. Although the ease with which a magnetic stripe can be cloned is a security liability, some companies have exploited this property to provide card aggregators that allow consumers to aggregate multiple magnetic swipe cards into a single credit card sized device. The underlying technology is magnetic stripe emulation which allows the device to replay a number of pre-stored magnetic stripes.

### BRIEF DESCRIPTION OF THE DRAWINGS

FIG. 1 is a block diagram of a system for aggregating secured credentials;

FIG. 2 is a block diagram of an EMV card aggregation device;

FIG. 3 is a process flow diagram of a method for aggregating multiple secured credentials on one device;

FIG. 4 is a process flow diagram of a method for performing a cryptocurrency transaction with a secured credential aggregator; and

FIG. 5 is a process flow diagram of a method for performing an EMV transaction with a secured credential aggregator.

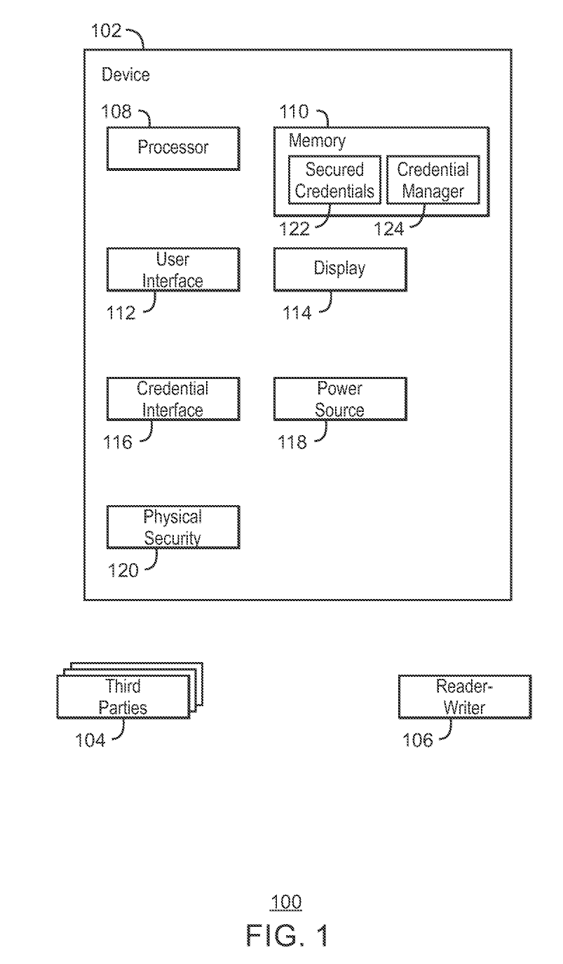

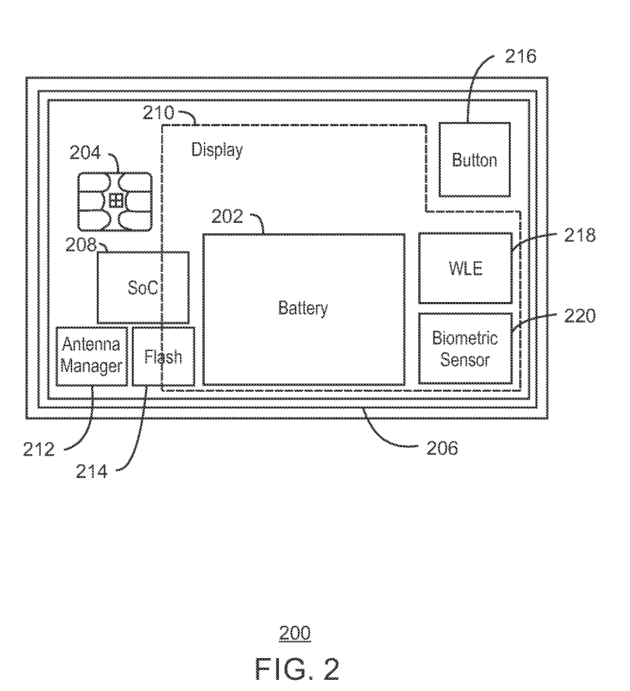

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of the computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. Moreover, the methods and systems described herein are not limited to physical computing devices, but may also relate to software optimizations for energy conservation and efficiency. As will become readily apparent in the description below, the embodiments of methods, apparatus′, and systems described herein (whether in reference to hardware, firmware, software, or a combination thereof) are vital to a ‘green technology’ future balanced with performance considerations.

As a response to the problem of skimming, the credit card and banking industry in Europe and Asia deployed EMV (Europay MasterCard® and Visa®) in the mid 2000's. This was launched as, “Chip and PIN,” which describes the two-factor authentication model used to validate transactions, the two factors being something owned, and something known, i.e., the embedded chip on a smartcard, and the PIN. EMV cards leverage smartcard technology, which embeds a secure computing device into the card. However, known card aggregation devices are dependent on magnetic stripe technology. As the U.S. transitions to EMV to align with Europe and Asia, aggregation devices based on magnetic stripe technology will become obsolete.

FIG. 1 is a block diagram of a system 100 for aggregating secured credentials. The system 100 includes a device 102, third parties 104, and a reader-writer 106. The device 102 is a credit-card form factor device onto which multiple third parties 104 may securely provision their secured credentials using the reader-writer 106. Additionally, the device 102 may emulate the secured credential, for reading by the reader-writer 106. The reader-writer 106 may communicate with the device 102 through a physical, or a wireless, connection.

The credentials stored on EMV-compliant cards are a specific type of third party secured credentials. These cards are issued by a third party, typically a financial institution. However, other institutions interested in security may also use secured credentials. For example, a corporate security department may issue secured credentials to enable secure logons in a corporate network. Thus, while the techniques of aggregating third-party secured credentials are discussed with respect to EMV-compliant cards, other types of third-party secured credentials may be aggregated as described herein.

In one embodiment, the device 102 is EMV-compliant. EMV-compliant card aggregation raises some challenges. The smartcard technology on which EMV is deployed is inherently cloning resistant. These anti-cloning features pose a particular challenge for aggregating multiple EMV cards on a single device. It is not possible to simply use a magnetic card reader to read cards and store or replay the data on the device 102. Instead, the secured credential associated with each third party 104 is provisioned onto the device 102 with the cooperation of the third party 104.

It is also possible to use the device 102 to aggregate cryptocurrency. Cryptocurrency is a digital currency, issued as tokens, where the medium of exchange uses cryptography to secure transactions. Bitcoin is one well-known cryptocurrency, but other cryptocurrencies also exist. With regard to cryptocurrencies, the credential is not provisioned by a third party, but by the owner of the cryptocurrency. Cryptocurrency tokens are typically secured in a digital wallet, or a digital vault. Provisioning cryptocurrency tokens onto the device 102 involves moving the tokens out of the digital wallet or vault.

The device 102 includes a processor 108, a memory 110, a user interface 112, a display 114, a credential interface 116, a power source 118, and physical security 120. The processor 108 may be a set of circuits embedded into the device, such as with a smartcard. The memory 110 may be storage elements, such as static random access memory (SRAM), and flash memory. The memory includes secure, non-volatile storage for security critical parameters such as EMV credentials, cryptographic keys, or cryptocurrency. The processor 108 executes instructions stored in, and accesses data stored in, the memory 110.

The memory 110 includes secured credentials 122 and a credential manager 124. In the memory 110, the secured credentials 122 of multiple card issuers are isolated from each other. The credential manager 124 communicates with the third party 104 to obtain, and emulate, the secured credentials 122.

The user interface 112 enables a user to select one of the secured credentials 122 for emulation. In one embodiment, the user interface 112 is a button. In response to a button press, the credential manager 124 displays an image associated with one of the secured credentials 122, i.e., a credit card image. By repeatedly pressing the button, each secured credential 122 may be scrolled in sequence on the display 114. The display 114 enables the third party's brand, or other identifier, to be vibrantly displayed when their secured credential 122 is selected.

The reader-writer 106 communicates with the device 102 through the credential interface 116. The credential interface 116 may be a contact, or contactless, interface. A contact interface may include contact pads, such as on a smartcard. A contactless interface may be a wireless interface, such as an antenna embedded in the device 102 for low energy wireless communication.

The power source 118 may be a battery, with a lifetime that is compliant to the ISO7816 smart card standard. In one embodiment, the power source is a rechargeable lithium polymer battery.

The physical security 120 protects the card in ways that may help satisfy security requirements of the third parties 104, and the owner of the device 102. More specifically, the physical security 120 gives assurance that a credentials are stored securely on the device with negligible probability of compromise through non-invasive, semi-invasive and fully-invasive attacks on the device 102. Sophisticated hardware security measures may raise the difficulty of cloning attacks to uneconomic levels. The physical security 120 may include anti-decapsulation detectors, defenses against clock and voltage glitch attacks, and fault-induction attacks, anti-probing defenses, glue logic layout, dummy logic, and side-channel mitigations. Anti-decapsulation detectors operate by changing the circuit behavior when attempts are made to remove the encapsulation material within which the device die is embedded. Transistor junctions operating as photoelectric diodes are randomly placed within the overall device, and when activated by incident light, cause zeroing or overwriting of the data in non-volatile storage under active power or when power is next applied. Alternatively, other disabling functions may be used to render the device inoperative. Fault injection attacks based on clock manipulation may be mitigated by using an on-die Phase Locked Loop to detect clock glitches and stopped or slow clocks. Additionally, an on-die ring oscillator is used as a reference against which to detect overclocking of the device. Fault induction on the power supply network, for example, by voltage glitching, is mitigated by on-die voltage regulation which decouples the on-die power supply network from the external power source. Fault inductions attacks are mitigated by ensuring single- or multi-bit flips in security critical regions of the circuit caused by thermal or electromagnetic incident radiation cannot affect a disabling or manipulation of security features or critical data. This is achieved by using multi-bit or redundant encoding schemes for control and data functions. Anti-probing defenses protect against invasive attacks using a combination of dense metal routing stacks. Metal routing stacks are metal routings that vertically span the metal stack thus ensuring that circuit behavior is disabled as the attacker removes metal layers. Additionally, using fine metal linewidths for security critical features, and avoiding large metal structures that could act as probe points for the attacker can mitigate physical attacks. A glue logic layout means that the circuitry for the processor 108 is laid out in a non-hierarchical, randomized way. This increases the difficulty for attackers to map device functions to areas on the die, knowledge which could better inform an invasive- or semi-invasive attack strategy. The dummy logic refers to dummy circuitry in the processor. This dummy circuitry serves as a decoy to attackers looking for vulnerabilities in the device 102. Side-channel mitigations are clock- and data-randomization techniques which serve to obfuscate the power- and EM-signatures that the device emits when performing security functions. These mitigations are implemented at the micro-architectural level. Other side-channels such as timing- and cache-side channels are mitigated at the software level.

Once provisioned, the user can select the desired credential by cycling through the secured credentials 122 using the interface 116. A thin-film display such as a flexible OLED display provides visual feedback as to the currently selected credential. The display 114 allows card issuers, or other third parties 104, to ensure that the appropriate branding is clearly visible, and provides for display of other data such as, account number (or some subset of the number), expiration dates, signature, photo of the credential owner, or other information. In addition, the device 102 may also be used as a secure storage device, or wallet, for cryptocurrency tokens.

FIG. 2 is a block diagram of an EMV card aggregation device 200. The EMV card aggregation device 200 is a credit-card form factor device which operates as an active smartcard, i.e., it is powered by battery 202, such as a lithium polymer battery. The device allows multiple third parties 104 to securely provision their EMV credentials onto the device 200 through a wireless interface, such as wireless low energy (LE).

The device 200 assumes the form factor of a standard dual-interface smartcard, includes the contact pads 204 for contact readers, and an embedded antenna 206 for contactless operation. In one embodiment, the embedded antenna 206 is a low energy wireless antenna. The device 200 implements the ISO14443 protocol used for smartcard contactless payment with the embedded antenna 206 and the antenna subsystem. Alternatively, other wireless connectivity standards capable of meeting the power budget may be used. The antenna 206 provides wireless connectivity for device management, EMV credential provisioning, and proximity detection to other mobile devices for the same user.

The device 200 is an active smartcard, i.e., the device 200 includes its own power supply in the form of the battery 202. The battery 202 provides power to the device when not inserted into a card reader. The battery may be a non-rechargeable lithium polymer battery, or a rechargeable lithium polymer battery. In one embodiment, the rechargeable battery is recharged using smartcard contacts, wireless charging, and energy harvesting. The card reader may be a contact reader or contactless, if the power budget permits. Additionally, the device 200 may include a DC switchover mechanism that allows the card to be powered from a card reader thus saving battery power when used in contact readers.

The device also includes a system on a chip (SoC) 208. The SoC 208 provides general compute capability for the device 200. Functions include hosting multiple emulated smartcards, and managing input-output (I/O). In one embodiment, the SoC 208 has 5V tolerant I/O to meet the 5V electrical signaling requirements used by smartcards. Additional features provided by the SoC 208 are embedded SRAM and flash, or other non-volatile memory, and may include application-specific hardware peripherals such as, display driver circuitry and security accelerators.

The SoC 208 may also have a number of integrated features: 3DES (Triple Data Encryption Standard) symmetric and RSA (Rivest Shamir Adleman) asymmetric cryptographic hardware accelerators, and a biometric hardware accelerator. The biometric hardware accelerator is used with a biometric sensor that provides strong user authentication preventing unauthorized users from using the card. Additionally, the SoC 208 may integrate lightweight isolated execution and memory protection to enable hardware-enforced separation of EMV application code and data. Further, the SoC 208 may integrate secure non-volatile storage for security critical parameters such as EMV credentials, cryptographic keys, or cryptocurrency tokens, and display driver circuitry for an organic, light-emitting diode (OLED) thin-film display 210. In one embodiment, the antenna subsystem is integrated into the SoC 208. Further, the wireless LE subsystem could also be integrated into the SoC 208.

The display 210 is a low-power, thin-film, color display that provides for device output to the user such as, displaying which EMV card is currently selected, and providing user feedback for device configuration. In one embodiment, the display 210 is a thin-film organic led (OLED) display. The display driver circuitry may be a monolithic chip or integrated into the SoC 208.

Further, the SoC 208 implements defenses against non-invasive, semi-invasive and fully-invasive attacks. These defenses include one or more anti-decapsulation detectors taking the form of a photo-diode. Should light be detected due to a decapsulation attempt, EMV credentials are actively wiped, or wiped on next power-up. Defenses also include an anti-probing top layer metal shield which, when compromised, initiates wiping of EMV credentials. The SoC 208 also includes mitigations against software, timing, power and EM side channels. Additionally, defenses may include on-die voltage regulation used as a defense against power-side channel analysis. The physical design uses a non-hierarchical, randomized layout as a defense. The physical design also employs dummy structures to increase the difficulty of reverse engineering. Additionally, fault induction attacks are mitigated by the device 102 by ensuring that no single point of failure can be exploited.

The device 200 also includes external flash memory 214. The external flash memory 214 is used for bulk storage of non-critical data. For example, the smartcard issuer may provide bitmaps for display when their smartcard is selected. These bitmaps may be stored in the external flash memory 214. This external flash memory 214 can also be used for encrypted storage where data is encrypted or decrypted by the SoC 208. Additionally, the device 200 includes a button 216. The button 216 is used to cycle through the set of provisioned EMV cards stored on the device 200, and also to bring the device 200 out of sleep mode. In one embodiment, the button 216 also cycles through any other types of secured credentials stored on the device 200, such as cryptocurrencies.

The wireless low energy (WLE) unit 218 provides wireless connectivity to the device 102 for device management, EMV credential provisioning, and proximity detection to user mobile devices. In one embodiment, the WLE unit 218 is Bluetooth Low Energy (BLE). Other wireless connectivity standards capable of meeting the power budget may also be appropriate. The WLE unit 218 could also be integrated into the SoC 208. The biometric sensor 220 provides strong user authentication to prevent unauthorized users from using the device 200.

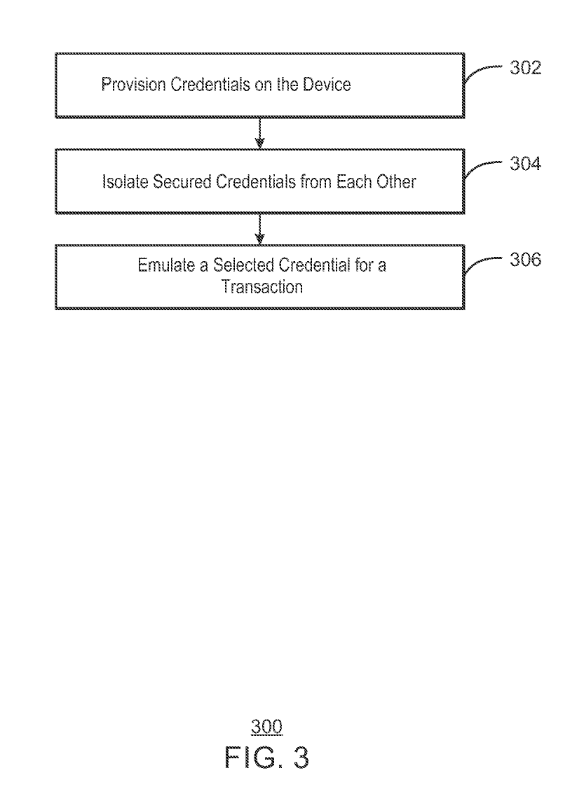

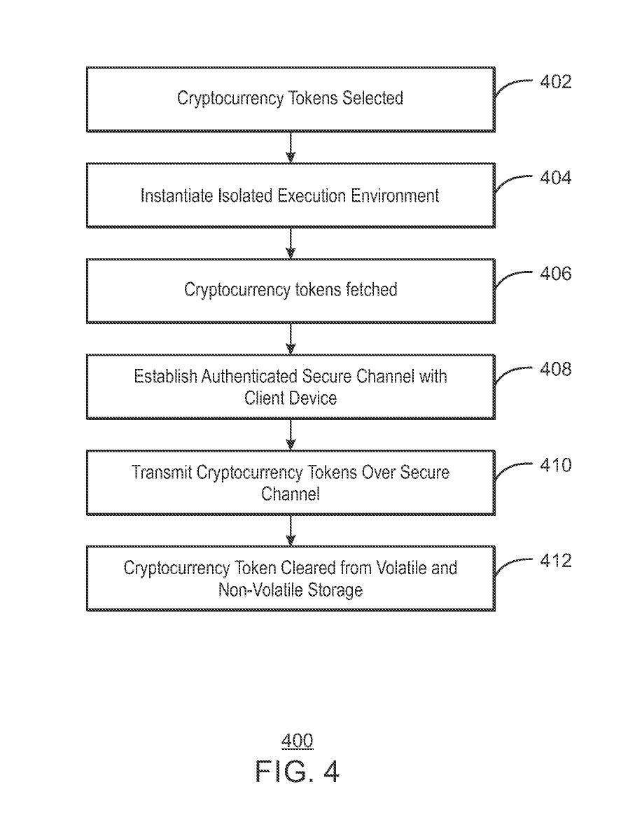

FIG. 3 is a process flow diagram of a method 300 for aggregating multiple secured credentials on one device. The method 300 is performed by the credential manager 124, and begins at block 302 where a plurality of secured credentials is provisioned on the device 102. The credentials may be provisioned by a third party, or by the user of the device 102. At block 304, the secured credentials are isolated from each other in memory. At block 306, a selected secured credential is emulated for a transaction. The emulation is the same as would be provided by a smart card, for example. In the case of cryptocurrencies, a method of emulation is described with respect to FIG. 4.

FIG. 4 is a process flow diagram of a method 400 for performing a cryptocurrency transaction with a secured credential aggregator. A cryptocurrency transaction is a financial transaction where the payment is made using a cryptocurrency. The method 400 begins at block 402, where the cryptocurrency tokens are selected. In one embodiment, pushing a user interface, such as the button 216, cycles through the secured credentials stored on the card. An image associated with each credential is shown on the display 210. When the image associated with the cryptocurrency is displayed, the user may indicate a selection with a double press of the button 216. Further presses of the button 216 in response to images shown on the display 210 allow the user to select the number of cryptocurrency tokens required.

At block 404, the credential manager 124 instantiates an isolated execution environment. The isolated execution environment provides hardware-underpinned security guarantees for the credentials 122 by ensuring that all code and data associated with the transaction cannot be accessed by other code in the system. In this way, any undetected security vulnerabilities in the system software are effectively contained.

At block 406, the selected cryptocurrency tokens are fetched from non-volatile storage. The fetched cryptocurrency tokens are placed in volatile storage.

At block 408, the credential manager 124 establishes an authenticated, secure channel with a reader-writer 106. The authenticated, secure channel may be encrypted to prevent any eavesdropping.

At block 410, the credential manager 124 transmits the selected cryptocurrency tokens over the secure channel. At block 412, the credential manager clears the selected cryptocurrency tokens from volatile and non-volatile storage.

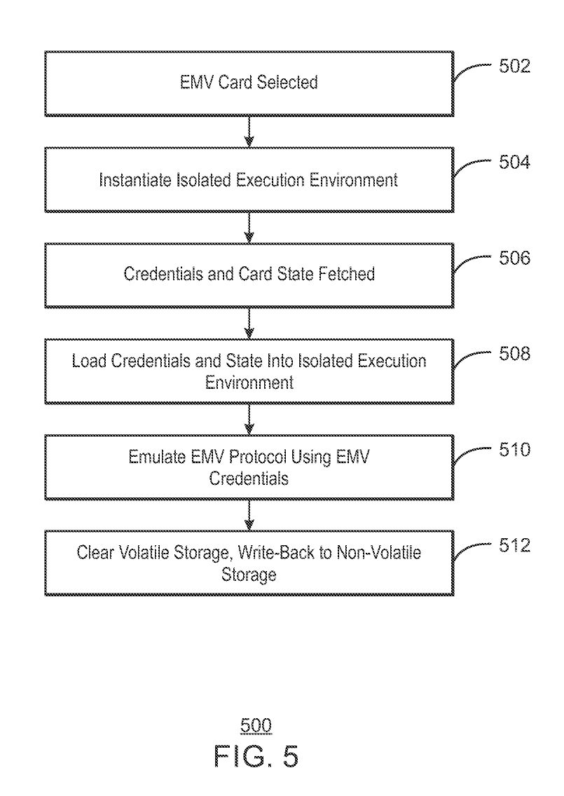

FIG. 5 is a process flow diagram of a method 500 for performing an EMV transaction with a secured credential aggregator. The method begins at block 502, where the EMV card is selected. At block 504, the credential manager 124 instantiates an isolated execution environment.

At block 506, the EMV credential for the selected EMV is fetched, along with a card state. The card state encompasses all state associated with the selected card that is necessary to successfully resume emulation of the EMV card. The card state provides persistent data to be used during the emulation. In one embodiment, to correctly emulate the card, a card state may be needed from the most previous use of the card. For example, the card state may provide a transaction count, or a timestamp of the last transaction.

At block 508, the credential and card state are loaded into the isolated execution environment. The isolated execution environment provides hardware-underpinned security guarantees for the credentials and card state by ensuring that all code and data associated with the transaction cannot be accessed by other code in the system. In this way, any undetected security vulnerabilities in the system software are effectively contained.

At block 510, the credential manager 124 emulates the EMV protocol using the selected EMV credential and card state. At block 512, the credential manager 124 clears volatile storage. Additionally, the credential manager 124 writes the card state and selected credential back to non-volatile storage.

### Examples

An example apparatus aggregates secured credentials. The apparatus includes a processor and a memory. The memory includes code causing the processor to provision a plurality of secured credentials on the apparatus. Additionally, the code causes the processor to isolate the secured credentials from each other in the memory. Further, the code causes the processor to emulate a selected secured credential from the secured credentials for a transaction.

An example apparatus includes a display and a user interface. The user interface enables selection of the selected secured credential. The user interface includes a button. Pressing the button when the apparatus is asleep wakes the apparatus. Subsequent button presses display a representation of each of the secured credentials.

An example apparatus includes a biometric sensor that prevents an unauthorized user from using the apparatus. An example apparatus includes a credential interface. The credential interface is used for provisioning the secured credentials, and emulating the selected secured credential. The credential interface includes smartcard contacts. The credential interface includes an embedded antenna.

An example apparatus of claim 1 includes a power source and a DC switchover mechanism. The power source includes a rechargeable battery. The DC switchover mechanism enables the apparatus to be powered from a card reader.

An example method aggregates secured credentials on an apparatus. The method includes provisioning a plurality of secured credentials on the apparatus. The method also includes isolating the secured credentials from each other in the memory. Further, the method includes emulating a selected secured credential from the secured credentials for a transaction.

In an example method, the apparatus includes a display and a user interface. The user interface enables selection of the selected secured credential. The method includes waking the apparatus in response to a selection using the user interface. The method additionally includes displaying a representation of each of the secured credentials in response to subsequent button presses.

An example method uses a biometric sensor to prevent an unauthorized user from using the apparatus. In an example method, the apparatus comprises a power source comprising a rechargeable battery. The method also includes recharging the rechargeable battery using a DC switchover mechanism that enables the apparatus to be powered from a card reader. The apparatus includes the DC switchover mechanism.

In an example method, the apparatus comprises a display. The method additionally includes displaying, on the display, an image associated with the selected secured credential in response to a user selection.

An example system aggregates secured credentials. The system includes means to provision a plurality of secured credentials on the system. The system also includes means to isolate the secured credentials from each other in the memory. Further, the system includes means to emulate a selected secured credential from the secured credentials for a transaction.

Additionally, the system includes a display, and a user interface. The user interface enables selection of the selected secured credential. The user interface includes a button. Pressing the button when the system is asleep wakes the system. Subsequent button presses display a representation of each of the secured credentials.

An example system includes a biometric sensor that prevents an unauthorized user from using the system. An example system includes a credential interface. The credential interface is used for provisioning the secured credentials, and emulating the selected secured credential. The credential interface includes smartcard contacts. The credential interface includes an embedded antenna.

An example system includes a power source. The power source is a rechargeable battery. The example system includes a DC switchover mechanism that enables the system to be powered from a card reader.

An example computer-readable medium aggregates secured credentials on an apparatus. The computer-readable medium includes code to direct a processor to provision a plurality of secured credentials on the apparatus. The code directs the processor to isolate the secured credentials from each other in a memory of the apparatus. Additionally, the code directs the processor to emulate a selected secured credential from the secured credentials for a transaction.

In an example computer-readable medium, the apparatus includes a display and a user interface. The user interface enables selection of the selected secured credential. The user interface includes a button. Pressing the button when the apparatus is asleep wakes the apparatus. Subsequent button presses display a representation of each of the secured credentials.

In an example computer-readable medium, the apparatus includes a biometric sensor that prevents an unauthorized user from using the apparatus. The apparatus includes a credential interface. The credential interface is used for provisioning the secured credentials, and emulating the selected secured credential. The credential interface includes smartcard contacts. The credential interface includes an embedded antenna.

In an example computer-readable medium, the apparatus includes a power source. The power source includes a rechargeable battery. The apparatus includes a DC switchover mechanism that enables the apparatus to be powered from a card reader.

In an example apparatus for aggregating secured credentials, the apparatus includes a processor and a memory. The memory includes code causing the processor to provision a plurality of secured credentials on the apparatus. The code causes the processor to isolate the secured credentials from each other in the memory. Additionally, the code causes the processor to emulate a selected secured credential from the secured credentials for a transaction. Further, apparatus includes a credential interface used for provisioning the secured credentials, and emulating the selected secured credential.

An example apparatus includes a display and a user interface. The user interface enables selection of the selected secured credential. The user interface includes a button. Pressing the button when the apparatus is asleep wakes the apparatus. Subsequent button presses display a representation of each of the secured credentials.

An example apparatus includes a biometric sensor that prevents an unauthorized user from using the apparatus. The credential interface includes smartcard contacts. The credential interface includes an embedded antenna.

An example apparatus includes a power source. The power source includes a rechargeable battery. The apparatus includes a DC switchover mechanism that enables the apparatus to be powered from a card reader.

Not all components, features, structures, characteristics, etc., described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, the flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for aggregating secured credentials, the apparatus comprising:
a processor;
a memory comprising code causing the processor to:
provision a plurality of secured credentials on the apparatus;
isolate the secured credentials from each other in the memory; and
emulate a selected secured credential from the secured credentials for a transaction.

2. The apparatus of claim 1, comprising:
a display; and
a user interface that enables selection of the selected secured credential.

3. The apparatus of claim 2, wherein the user interface comprises a button, wherein pressing the button when the apparatus is asleep wakes the apparatus.

4. The apparatus of claim 3, wherein subsequent button presses display a representation of each of the secured credentials.

5. The apparatus of claim 1, comprising a biometric sensor that prevents an unauthorized user from using the apparatus.

6. The apparatus of claim 1, comprising a credential interface, wherein the credential interface is used for provisioning the secured credentials, and emulating the selected secured credential.

7. The apparatus of claim 6, wherein the credential interface comprises smartcard contacts.

8. The apparatus of claim 6, wherein the credential interface comprises an embedded antenna.

9. The apparatus of claim 1, comprising a power source.

10. The apparatus of claim 9, the power source comprising a rechargeable battery.

11. The apparatus of claim 10, comprising a DC switchover mechanism that enables the apparatus to be powered from a card reader.

12. A method for aggregating secured credentials on an apparatus, the method comprising:
provisioning a plurality of secured credentials on the apparatus;
isolating the secured credentials from each other in the memory; and
emulating a selected secured credential from the secured credentials for a transaction.

13. The method of claim 12, comprising waking the apparatus in response to a selection using a user interface of the apparatus.

14. The method of claim 13, comprising displaying a representation of each of the secured credentials in response to subsequent button presses.

15. The method of claim 12, comprising using a biometric sensor to prevent an unauthorized user from using the apparatus.

16. The method of claim 12, wherein the apparatus comprises a power source comprising a rechargeable battery.

17. The method of claim 16, comprising recharging the rechargeable battery using a DC switchover mechanism that enables the apparatus to be powered from a card reader.

18. The method of claim 17, wherein the apparatus comprises the DC switchover mechanism.

19. The method of claim 12, wherein the apparatus comprises a display.

20. The method of claim 19, comprising displaying, on the display, an image associated with the selected secured credential in response to a user selection.
